(19) United States
(12) Patent Application Publication
(10) Pub. No.: US 2021/0323514 A1
(43) Pub. Date: Oct. 21, 2021

(54) ELECTROHYDRAULIC BRAKE APPARATUS

(71) Applicant: HYUNDAI MOBIS CO., LTD., Seoul (KR)

(72) Inventor: Ha Min JUNG, Hwaseong-si (KR)

(21) Appl. No.: 17/229,927

(22) Filed: Apr. 14, 2021

(30) Foreign Application Priority Data
Apr. 17, 2020 (KR) 10-2020-0046609

(51) Int. Cl. B60T 7/04; B60T 8/40; B60T 13/68

(52) U.S. Cl. CPC B60T 7/042; B60T 13/686; B60T 8/4081

(57) ABSTRACT

An electrohydraulic brake apparatus includes: a plurality of wheel brake assemblies; an electric booster including a motor for boosting a pedal force applied to a brake pedal; an electronic stability control system including a pressure sensor for measuring a hydraulic pressure and configured to open or close a plurality of valves disposed therein to distribute the hydraulic pressure to the plurality of wheel brake assemblies; and an electronic control unit configured to control a driving current of the motor within a range of a current value of smaller than or equal to a first limit current when the hydraulic pressure measured by the pressure sensor is smaller than or equal to a first reference, and control the driving current of the motor within a range of the current value of larger than the first limit current and smaller than or equal to a second limit current when the hydraulic pressure is larger than the first reference.

### TECHNICAL FIELD

The present invention relates to an electrohydraulic brake apparatus.

### BACKGROUND ART

The statements in this section merely provide background information related to the present disclosure and do not necessarily constitute prior art.

A brake apparatus includes a reservoir, one or more lines, and a plurality of wheel brake assemblies. A brake fluid discharged from the reservoir flows into a plurality of wheel brakes through the one or more lines. This electrohydraulic brake apparatus brakes vehicle wheels with a pedal force of a driver.

However, in such a conventional electrohydraulic brake, when the driver presses a pedal, a boosting limit of a motor of an electric booster is set constant regardless of the magnitude of a required braking force. That is, even when the required braking force is low, since the boosting limit of the motor is the same as the maximum value, a motor rated point is set high based on the boosting limit which is the maximum value.

Thus, a motor having a high torque specification should be used as the motor rated point is set high. Therefore, there are disadvantageous problems in terms of the cost-effectiveness of the motor.

### SUMMARY

According to at least one embodiment, the present disclosure provides an electrohydraulic brake apparatus comprising: a plurality of wheel brake assemblies configured to provide braking forces to wheels; an electric booster including a motor for boosting a pedal force applied to a brake pedal; an electronic stability control (ESC) system including a pressure sensor for measuring a hydraulic pressure and configured to open or close a plurality of valves disposed therein to distribute the hydraulic pressure to the plurality of wheel brake assemblies; and an electronic control unit (ECU) configured to control a driving current of the motor within a range of a current value of smaller than or equal to a first limit current when the hydraulic pressure measured by the pressure sensor is smaller than or equal to a first reference, and control the driving current of the motor within a range of the current value of larger than the first limit current and smaller than or equal to a second limit current when the hydraulic pressure is larger than the first reference.

### BRIEF DESCRIPTION OF DRAWINGS

FIG. 1 is a block diagram of an electrohydraulic brake apparatus according to one embodiment of the present invention.

FIG. 2 is a block diagram of an electronic stability control system according to one embodiment of the present invention.

FIG. 3 is a graph of input/output characteristics according to one embodiment of the present invention.

FIG. 4 is a graph of a TNI curve of a motor according to one embodiment of the invention.

### REFERENCE NUMBERS

110: main body 120: electric booster
130: electronic control unit 200: hydraulic control system
150: wheels
FL, RR, RL and FR: wheel brakes

### DETAILED DESCRIPTION

According to an embodiment of the present invention, an intermediate boosting point is set in low-response braking and a motor rated point is set based thereon. That is, the motor rated point is set lower than that of the conventional motor. As the motor rated point is set low, a required motor capacity decreases. The present invention is directed to providing an electric booster in which the size of a motor decreases and thus the price of the motor is reduced when the capacity of the motor decreases, thereby reducing a manufacturing cost of the electric booster.

Some exemplary embodiments of the present disclosure are described below with reference to the accompanying drawings. In the following description, like reference numerals preferably designate like elements, although the elements are shown in different drawings. Further, in the following description of some embodiments, a detailed description of known functions and configurations incorporated herein will be omitted for the purpose of clarity and for brevity.

Additionally, alphanumeric codes such as first, second, i), ii), (a), (b), etc., in numbering components are used solely for the purpose of distinguishing one component from another but not to imply or suggest the substances, the order or sequence of the components. Throughout this specification, when a part “includes” or “comprises” a component, the part is meant to further include other components, not to exclude, unless there is a specific description contrary thereto.

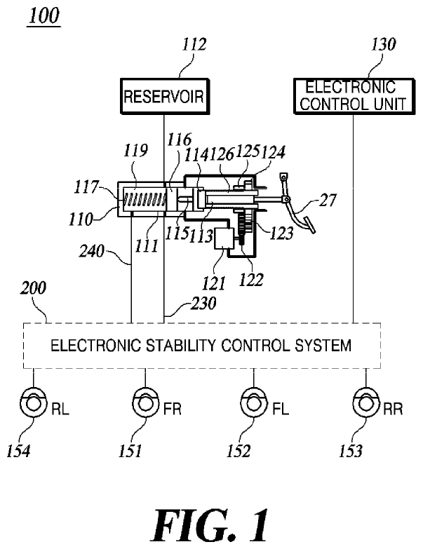

FIG. 1 is a block diagram of an electrohydraulic brake apparatus according to one embodiment of the present invention.

Referring to FIG. 1, an electrohydraulic brake apparatus 100 according to one embodiment of the present invention includes some or all of a main body 110, an electric booster 120, an electronic control unit 130, a hydraulic control system (hereinafter referred to as an electronic stability control (ESC) system) 200, and a plurality of wheel brake assemblies FR, FL, RR, and RL.

A main body 110 includes some or all of a main master cylinder 111, a reservoir 112, an operating rod 113, a reaction disc 114, and a push rod 115.

Here, the main master cylinder 111 is configured to compress a brake fluid to form a hydraulic pressure used for braking. The reservoir 112 is configured to store the brake fluid therein. The operating rod 113 is configured to transmit a pedal force of a driver to the reaction disc 114. The reaction disc 114 is configured to press the push rod 115. The push rod 115 is configured to press the inside of the main master cylinder 111.

An electric booster 120 includes some or all of a motor 121, a first gear 122, a second gear 123, a third gear 124, a nut screw 125, a bolt screw 126, and a brake pedal 127.

The first gear 122, the second gear 123, and the third gear 124 are gears that transmit the rotational movement of the motor 121 to the nut screw 125. The nut screw 125 receives the rotational movement of the motor 121 and causes the bolt screw 126 to move linearly.

A right end of the main master cylinder 111 is connected to a left end of the push rod 115 configured to press the main piston 16 of the main master cylinder 111 to generate a hydraulic pressure. A right end of the push rod 115 is connected to a left end of the reaction disc 114. A left end of the operating rod 113 is connected to the center of a right end of the reaction disc 114. The operating rod 113 is connected to the brake pedal 127 of the driver. According to this connection structure, the operating rod 113 presses the center of the right end of the reaction disc 114 with the pedal force of the brake pedal 127 of the driver.

The outer contour of the right end of the reaction disc 114 is connected to the bolt screw 126. The first gear 122 and the second gear 123 are rotated by receiving a torque from the motor 121 of the electric booster. This rotational movement is transmitted to the third gear 124. The third gear 124, to which the rotational movement of the first gear 122 and the second gear 123 is transmitted, transmits the torque generated due to the rotational movement to the nut screw 125. The bolt screw 126 linearly moves according to the rotational movement of the nut screw 125. The outer contour of the right end of the reaction disc 114 is thus pressed by the linear movement of the bolt screw 126. As a result, the push rod 115 is pressed by the pedal force of the brake pedal 127 of the driver and a boosting force of the electric booster 120.

The main master cylinder 111 is pressed by the push rod 115 to discharge a brake fluid in the main master cylinder 111 to an electronic stability control (ESC) system 200. The brake fluid discharged from the reservoir 112 is transmitted to the main master cylinder 111, and the brake fluid discharged from the main master cylinder 111 is transmitted to the ESC system 200.

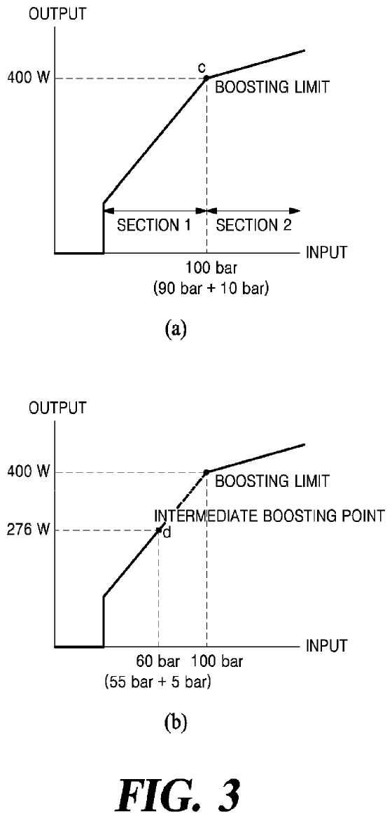

In the present disclosure, a case where the braking force is smaller than or equal to a first reference (60 bar) is referred to as low-response braking, and a case where a pedaling amount of the driver is greater than the first reference is referred to as high-response braking. In this case, the first reference means an intermediate boosting point (60 bar) of the graph of FIG. 3B.

A pressure sensor 201 is installed in the ESC system 200. When the driver presses the brake pedal 127, the pressure sensor 201 measures a hydraulic pressure value and transmits the hydraulic pressure value to an electronic control unit (ECU) 130.

Here, the pressure sensor 201 may be composed of a plurality of sensors. Since the ESC system 200 includes a plurality of pressure sensors 201, even when any one of the pressure sensors 201 has a problem and there is a problem with braking performance, the hydraulic pressure can be measured by another pressure sensor 201, and thus normal braking of wheel brakes FR, FL, RR, and RL by the ESC system 200 is possible. Since braking by the ESC system 200 is possible during emergency braking, redundancy of a hydraulic circuit can be ensured.

On the other hand, a conventional brake apparatus calculates a braking force requested by the driver by measuring an operating speed of the pedal or the like, but in the present disclosure, an actual hydraulic pressure is directly measured in the ESC system 200 and a measured value is used for control, and thus more precise control than in the conventional braking force measuring method is possible.

The ECU 130 receives a hydraulic pressure value measured by the pressure sensor 201.

When the received hydraulic pressure value is smaller than or equal to the first reference, the ECU 130 controls the electric booster 120 such that a current of a first limit current (e.g., 60 A) or more does not flow through the motor 121. The ECU 130 releases the restriction of the first limit current so that a current of 60 A or more can flow through the motor 121 when the received hydraulic pressure value is greater than the first reference. On the other hand, the electric booster 120 is controlled so that a current of a second limit current (for example, 100 A) or more does not flow through the motor 121. When a value of the current flowing through the motor 121 reaches a threshold value, the motor stops without further rotating, wherein the threshold value is a limit current.

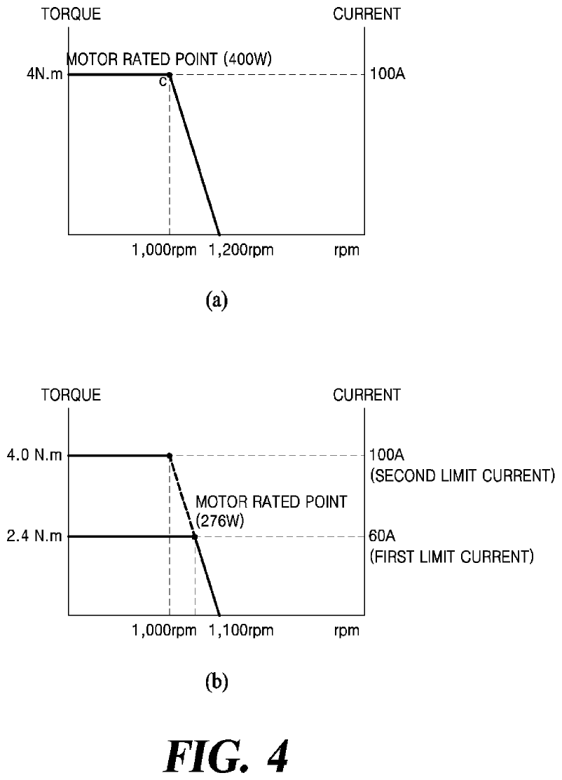

The capacity of the motor 121 is determined by a torque specification of the motor 121 and rpm of the motor 121, and in the present disclosure, as the intermediate boosting point (point d in FIG. 3) is set, the motor rated point is lowered from a point c of FIG. 4 to a point d of FIG. 4. Therefore, since the required torque specification and rpm required at the motor rated point are lower than those of the conventional motor, the motor 121 having a lower capacity can be used.

In low-response braking, the motor rated point is set based on the intermediate boosting point. Therefore, by setting the first limit current (for example, 60 A) at the motor rated point, the conventionally required motor capacity of 400 W decreases to 276 W. Therefore, since the motor 121 having a low capacity can be used, there is an effect of reducing the cost of the motor 121 of the electric booster 120.

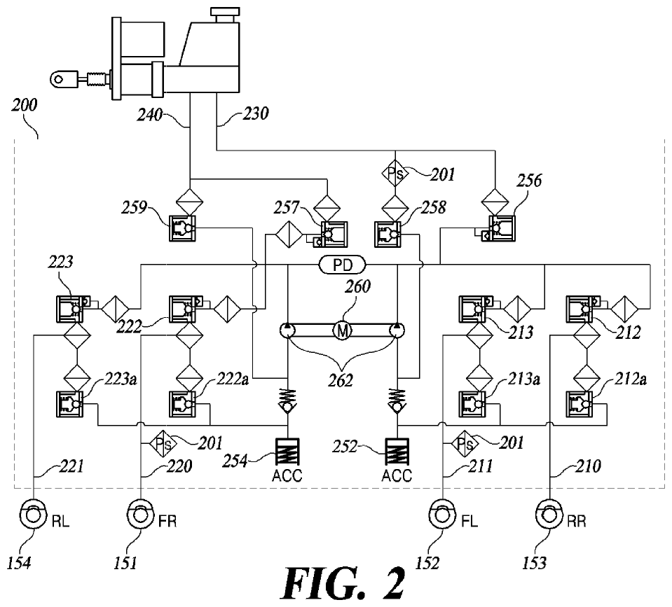

FIG. 2 is a block diagram of an ESC system according to one embodiment of the present invention.

Referring to FIG. 2, the ESC system 200 according to one embodiment of the present invention includes some or all of a pressure sensor 201, a first inlet line 210, a second inlet line 211, a third inlet line 220, a fourth inlet line 221, a first inlet valve 212, a second inlet valve 213, a third inlet valve 222, a fourth inlet valve 223, a first outlet valve 212a, a second outlet valve 213a, a third outlet valve 222a, a fourth outlet valve 223a, a first main line 230, a second main line 240, a plurality of accumulators 252 and 254, a plurality of traction control valves 256 and 257, a plurality of high-pressure switch valves 258 and 259, an actuator 260, and a hydraulic pump 262.

The plurality of wheel brakes FR, FL, RR, and RL include some or all of a first wheel brake FR for braking a front right wheel 151 of a vehicle, a second wheel brake FL for braking a front left wheel 152 of the vehicle, a third wheel brake RR for brake a rear right wheel 153 of a vehicle, and a fourth wheel brake RL for brake a rear left wheel 154 of the vehicle.

The first main line 230 and the second main line 240 are connected from the main master cylinder 111 to the ESC system 200. The first main line 230 and the second main line 240 are configured to transmit a brake fluid discharged from the main master cylinder 111 to the ESC system 200.

The plurality of wheel brake assemblies FR, FL, RR, and RL provide braking forces to the plurality of wheels 151, 152, 153, and 154 using a hydraulic pressure of the brake fluid discharged from the ESC system 200.

The ESC system 200 controls opening or closing of the plurality of traction control valves 256 and 257, the plurality of high-pressure switch valves 258 and 259, the actuator 260, the plurality of inlet valves 212, 213, 222, and 223, and the plurality of outlet valves 212a, 213a, 222a, and 223a so that the brake fluid is moved to the main master cylinder 111, the reservoir 112, and the plurality of wheel brake assemblies FR, FL, RR, and RL through the fluid line.

The plurality of traction control valves 256 and 257 are configured to interrupt the hydraulic pressure in the ESC system 200. A first traction control valve 256 may be appropriately disposed on a path of a line corresponding to the first main line 230, that is, supplying the hydraulic pressure to the second and third wheel brakes FL and RR. A second traction control valve 257 may be appropriately disposed on a path of a line corresponding to the second main line 240, that is, supplying the hydraulic pressure to the first and fourth wheel brake assemblies FR and RL.

Here, the term “interrupting the hydraulic pressure” refers to a process of opening or closing the plurality of valves in the ESC system 200 so that the hydraulic pressures supplied by the actuator 260 do not diffuse toward the main lines 230 and 240. Thus, the hydraulic pressure generated by the actuator 260 can be provided only in the ESC system 200.

The plurality of high-pressure switch valves 258 and 259 are configured to interrupt the hydraulic pressure of the brake fluid supplied to the inlet of the hydraulic pump 262. A first high-pressure switch valve 258 may be appropriately disposed on a path of a line corresponding to the first main line 230, that is, supplying the hydraulic pressure to the second and third wheel brakes FL and RR. A second high-pressure switch valve 259 can be appropriately disposed on a path of a line corresponding to the second main line 240, that is, supplying the hydraulic pressure to the first and fourth wheel brakes FR and RL.

The plurality of outlet valves 212a, 213a, 222a, and 223a are disposed on the plurality of outlet lines 210a and 220a. The plurality of outlet valves 212a, 213a, 222a, and 223a are configured to interrupt the hydraulic pressures discharged from the plurality of wheel brakes FR, FL, RR, and RL.

The ESC system 200 may further include low-pressure accumulators 252 and 254. The plurality of accumulators 252 and 254 are configured to temporarily store the brake fluid discharged from the plurality of wheel brakes FR, FL, RR, and RL. Meanwhile, the accumulators 252 and 254 may be disposed inside the ESC system 200.

The first inlet line 210 includes the first inlet valve 212. The second inlet line 211 includes the second inlet valve 213. The first inlet valve 212 is disposed adjacent to the first wheel brake FR, and the second inlet valve 213 is disposed adjacent to the second wheel brake FL. The third inlet line 220 includes the third inlet valve 222. The fourth inlet line 221 includes the fourth inlet valve 223. The third inlet valve 222 is disposed adjacent to the third wheel brake RR, and the fourth inlet valve 223 is disposed adjacent to the fourth wheel brake RL.

The ESC system 200 opens or closes the plurality of inlet valves 212, 213, 222, and 223 to change the hydraulic pressure of the brake fluid in the plurality of inlet lines 210, 211, 220, and 221. That is, the first inlet line 210 transmits the brake fluid only to the wheel brake FR according to a change in hydraulic pressure. The second inlet line 211 transmits the brake fluid only to the wheel brake FL according to a change in hydraulic pressure. The third inlet line 220 transmits brake fluid only to the wheel brake RR according to a change in hydraulic pressure. The fourth inlet line 221 transmits brake fluid only to the wheel brake RL according to a change in hydraulic pressure.

A general description of the ESC system 200 is as follows.

A description of the plurality of wheel brakes FR, FL, RR, and RL is as follows.

An H-split structure is a structure in which two main lines control the front wheels 151 and 152 or the rear wheels 153 and 154. That is, the brake fluid transmitted from the first main line 230 controls only the front wheels 151 and 152, and the brake liquid transmitted from the second main line 240 controls only the rear wheels 153 and 154.

On the other hand, an X-split structure according to one embodiment of the present disclosure is a structure in which the two main lines 230 and 240 control one front wheel 151 or 152 and one rear wheel 153 or 154, respectively. In the X-split structure, the variation between hydraulic pressure values measured by the plurality of pressure sensors 201 is smaller than in the case of using the H-split structure. In the H-split structure, a hydraulic pressure value for controlling the front wheels and a hydraulic pressure value for controlling the rear wheels are respectively measured when the hydraulic pressure values are measured by respectively controlling the front wheels 151 and 152 and the rear wheels 153 and 154. On the other hand, in the X-split structure, the hydraulic pressure values are measured while crossing the front wheels and the rear wheels one by one in measuring the hydraulic pressure values. Thus, the X-split structure reduces a hydraulic deviation between the front wheel and the rear wheel as compared with the H-split structure.

In addition, since the ECU 130 of the present disclosure controls the electric booster according to an average value of the hydraulic pressure values measured by the plurality of pressure sensors 201, it is possible to obtain a more accurate measurement value because the deviation is reduced compared to the conventional measurement method using one sensor.

FIG. 3 is a graph of input/output characteristics according to one embodiment of the present invention.

The probability of a driver operating a brake during driving in the braking force range of 0 to 30 bar is 98%. The probability of operating in the braking force range of 0 to 60 bar is 99.7%. That is, the probability of a braking force of 60 bar or more is only 0.3%. When the probability of operating at above 60 bar is 0.3%, it will only occur 1,500 times out of 500,000 times.

As the driver presses the brake pedal, the electric booster boosts the pedal force of the driver to form a braking force of the vehicle. Here, the braking force is a resultant force of the pedal force of the driver and the boosting force of the motor.

Referring to FIG. 3A, in section 1, as a brake pedal force increases, the boosting force of the motor 121 also increases. On the other hand, in section 2, the boosting force generated by the motor no longer increases, and only the pedal force of the driver increases. The point between section 1 and section 2 is referred to as a boosting limit of the motor. The torque and rpm of the conventional motor at the boosting limit are values at a point c in FIG. 4A.

The motor operates constantly before the boosting force of the motor reaches the motor rated point. In this case, the constant operation means that a current flowing through the motor increases as the pedal force of the driver increases without limiting the current flowing through the motor. That is, after the motor rated point, a limit current is set in the motor so that the boosting force of the motor is no longer increased and is constant. Therefore, the braking force is increased only by an increase in the pedal force of the driver.

The size and capacity of the motor of the electric booster are determined by referring to the motor rated point of the input/output graph. The smaller the size and capacity of the motor, the lower the cost of the motor. When this motor rated point is low, the motor cost is reduced as the capacity and size of the motor are reduced, resulting in the cost-saving effect of the electric booster.

FIG. 3A is a graph of input/output characteristics of a conventional general electric booster.

The boosting force borne by the motor at the boosting limit (100 bar) is 90 bar and the pedal force of the driver is 10 bar. A motor capacity (torque×rpm) corresponding to 90 bar is referred to as a conventional motor rated point.

FIG. 3B is a graph of input/output characteristics of an electric booster according to one embodiment of the present disclosure. A boosting limit according to one embodiment of the present invention is 100 bar, which is the same as the graph of FIG. 3A. However, the electric booster according to one embodiment of the present invention sets an intermediate boosting point to 60 bar. Here, the intermediate boosting point is a portion (point d) where the solid line and the dotted line of the graph of FIG. 3B meet. The boosting force borne by the motor at the intermediate boosting point is 55 bar, and the pedal force of the driver is 5 bar. The motor capacity corresponding to 55 bar is referred to as the motor rated point according to one embodiment of the invention.

When the braking force is greater than or equal to 60 bar, the pressure sensor 201 of the ESC system 200 detects the braking force, and the ECU instantaneously releases the first limit current of 60 A. Thus, the current of up to a second limit current of 100 A may flow. When the intermediate boosting point of the motor 121 is set such that limit currents are different between a case where the required braking force is low and a case where the required braking force is high, it is possible to use a motor having an output of 276 W lower than 400 W, thereby reducing a cost.

FIG. 4 is a graph of a TNI curve of a motor according to one embodiment of the present invention.

When the maximum torque is 4 N*m, at the conventional motor rated point, a rotational speed is 1000 rpm and a current of up to 100 A may flow. After the boosting limit, the boosting force generated by the motor is fixed without further increase, and thus a current of up to 100 A may flow. Therefore, a limit current of the motor is 100 A. This is the motor rated point of the conventional motor, and in this case, an output of the motor is 400 W.

When the maximum torque is 2.4 N*m, at the motor rated point of the motor according to one embodiment of the present disclosure, a rotational speed is 1100 rpm, and a current of up to 60 A may flow. Therefore, the first limit current of the motor is 60 A. This is the motor rated point of the present disclosure, and in this case, an output of the motor is 276 W.

In low-response braking (60 bar or less) according to the present embodiment, the ECU sets the first limit current in the motor. In this case, the first limit current is, for example, 60 A. A current of up to 60 A may flow in the motor. That is, an output of the motor is 276 W as the intermediate boosting point of the motor is set to the motor rated point.

On the other hand, in high-response braking (above 60 bar), the ECU temporarily releases the first limit current of 60 A of the motor and sets the second limit current. In this case, the second limit current is, for example, 100 A. Accordingly, a current of up to 100 A may flow in the motor.

According to one embodiment of the present disclosure, the motor capacity can be reduced because the limit current, which is conventionally 100 A, is lowered to 60 A in low-response braking. That is, a motor having a motor capacity of 400 W is conventionally required, but a motor having a capacity of 276 W can be used as the motor according to the present disclosure. Thus, the size of the motor can be reduced as the motor capacity decreases. Consequently, it is possible to reduce a cost of the motor and reduce a manufacturing cost of the electric booster.

As described above, according to the present embodiment, a low-response braking section and a high-response braking section are separated, a low motor rated point is set in the low-response braking section, and a limited current of a motor rated point is temporarily released in the high-response braking section to correspond to a required braking force. Through this method, there is an effect of lowering the motor rated point of an electric booster, thereby reducing a price of a motor and reducing a manufacturing cost of the electric booster.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above descriptions but by the claims and equivalents thereof.

What is claimed is:

1. An electrohydraulic brake apparatus comprising:
a plurality of wheel brake assemblies configured to provide braking forces to wheels;
an electric booster including a motor for boosting a pedal force applied to a brake pedal;
an electronic stability control (ESC) system including a pressure sensor for measuring a hydraulic pressure and configured to open or close a plurality of valves disposed therein to distribute the hydraulic pressure to the plurality of wheel brake assemblies; and
an electronic control unit (ECU) configured to control a driving current of the motor within a range of a current value smaller than or equal to a first limit current when the hydraulic pressure measured by the pressure sensor is smaller than or equal to a first reference, and to control the driving current of the motor within a range of the current value larger than the first limit current and smaller than or equal to a second limit current when the hydraulic pressure is larger than the first reference.

2. The electrohydraulic brake apparatus of claim 1, wherein the sensor included in the ESC system is provided as a plurality of sensors.

3. The electrohydraulic brake apparatus of claim 2, wherein the ECU controls the driving current of the motor according to an average value of values measured by the plurality of pressure sensors.

4. The electrohydraulic brake apparatus of claim 1, wherein the ESC system has an X-split structure.

5. The electrohydraulic brake apparatus of claim 1, wherein the ESC system further includes:
a traction control valve configured to interrupt a hydraulic pressure supplied from a master cylinder as the brake pedal is pressed;
an inlet valve configured to interrupt the hydraulic pressure supplied to a plurality of wheel brakes;
an actuator configured to provide the hydraulic pressure to the plurality of wheel brakes; and
a high-pressure switch valve configured to interrupt the hydraulic pressure supplied from the master cylinder.

6. The electrohydraulic brake apparatus of claim 1, wherein the ESC system further comprises an outlet valve configured to adjust the hydraulic pressure supplied to the plurality of wheel brake assemblies.

7. A method of controlling an electrohydraulic brake, comprising:
measuring a hydraulic pressure value by a pressure sensor provided in an electronic stability control (ESC) system;
transmitting the hydraulic pressure value to an electronic control unit (ECU); and
controlling a driving current of a motor within a range of a current value of smaller than or equal to a first limit current when the hydraulic pressure value is smaller than or equal to a first reference, and controlling the driving current of the motor within a range of the current value of larger than the first limit current and smaller than or equal to a second limit current when the hydraulic pressure value is larger than the first reference.

8. The method of claim 7, wherein the measuring a hydraulic pressure value includes measuring the hydraulic pressure in the ESC system having an X-split structure.

9. The method of claim 7, wherein the measuring a hydraulic pressure value includes obtaining an average value of hydraulic pressure values measured by a plurality of pressure sensors.
